(19) United States
(12) Patent Application Publication
(10) Pub. No.: US 2024/0294177 A1
(43) Pub. Date: Sep. 5, 2024

(54) CRASH AVOIDANCE VIA INTELLIGENT INFRASTRUCTURE

(71) Applicant: Continental Automotive Systems, Inc., Auburn Hills, MI (US)

(72) Inventors: Ulrich Stählin, Eschborn (DE); Brian J. Marlett, Macomb, MI (US); Mitchell E. Clelland, Commerce Township, MI (US); Paul D. Bingham, Canton, MI (US)

(73) Assignee: Continental Automotive Systems, Inc., Auburn Hills, MI (US)

(21) Appl. No.: 18/177,008

(22) Filed: Mar. 1, 2023

(51) Int. Cl. B60W 50/02; B60W 30/09; B60W 60/00

(52) U.S. Cl. CPC B60W 50/0205; B60W 30/09; B60W 60/0016; B60W 2050/0215; B60W 2556/45

(57) ABSTRACT

A vehicle safety control system for performing driver-assisted vehicle functions, semi-autonomous vehicle functions, or autonomous vehicle functions of the vehicle via intelligent infrastructure to supplement or replace sensor data of vehicle sensors damaged as a result of a vehicle collision or accident.

### BACKGROUND

### 1. Field

The present application relates to vehicle safety, and more particularity to vehicle control for avoiding collisions via intelligent infrastructure.

### 2. Description of Related Art

The safety and security of vehicle occupants has been a priority focus for governments, agencies, manufacturers, and advocacy groups. Accordingly, many vehicle systems have been developed in response to increasing demand for vehicle systems adapted to provide improved vehicle passenger safety.

In particular, avoidance and mitigation of secondary vehicle crashes are concerns of investigation with respect to passenger safety. As the possibility that frequency of primary accidents might be reduced with the advancement of collision avoidance systems, semi-autonomous vehicles, or autonomous vehicles, reducing the severity of collisions through secondary collision avoidance may be considered.

Vehicles can be equipped with various sensors, which enable driver-assisted vehicle functions, semi-autonomous vehicle functions, or autonomous vehicle functions including braking control, speed control, navigation, and the like. For example, a vehicle might be equipped with image sensors, RADAR sensors, LIDAR sensors, and any number of other sensors for detecting objects and conditions of an environment surrounding the vehicle to assist a vehicle driver with, or independently perform, vehicle control. However, as a result of a primary collision, any of various vehicle systems can become damaged, including vehicle sensors that might be susceptible to damage, malfunction, or misalignment during collisions due to placement on vulnerable locations near an exterior of the vehicle.

Damaged sensors and other vehicle systems might partially or completely preclude the vehicle from performing one or more of driver-assisted vehicle functions, semi-autonomous vehicle functions, or autonomous vehicle functions. Accordingly, a vehicle can possess only reduced collision avoidance capabilities after a primary collision.

Systems for avoiding and mitigating secondary collisions are therefore desirable despite damage to a vehicle as a result of a primary collision.

Intelligent infrastructure can supplement the detection of objects and conditions of an environment surrounding the vehicle to assist a vehicle driver with, or independently perform, vehicle control.

### SUMMARY

Aspects of embodiments of the present application relate to a vehicle safety and control system utilizing information received via intelligent infrastructure in communication with the vehicle, and a method of controlling a vehicle for performing secondary crash avoidance and mitigation utilizing information received via intelligent infrastructure in communication with the vehicle.

According to aspects of the embodiments, information with respect to objects and conditions of an environment surrounding the vehicle may be provided by intelligent infrastructure in communication with a vehicle. Thereby, an alternative or supplemental source of information may be utilized by the vehicle for performing vehicle safety and control to avoid secondary collisions when sensor systems of a vehicle may become damaged during a primary collision. Thereby, vehicle systems may leverage the detection and processing capabilities of intelligent infrastructure unavailable to the vehicle as a result of damaged sensors of the vehicle.

According to aspects of the embodiments, a redundancy to vehicle and sensor detection systems may be provided. Thereby, vehicle safety and control to avoid secondary collisions is maintained when sensor systems of a vehicle may become damaged during a primary collision.

According to an aspect of an embodiment, there is provided a safety control system of a vehicle, including a sensor configured to output sensor data corresponding to an object in an environment surrounding the vehicle; a transceiver; a memory storing computer-readable instructions; and a control unit configured to, when executing the computer-readable instructions, control to determine the sensor is inoperable or unreliable, control the transceiver to transmit to an intelligent infrastructure a request for data to assist the vehicle to perform at least one of driver-assisted vehicle functions, semi-autonomous vehicle functions, or autonomous vehicle functions of the vehicle, based on determining the sensor is inoperable or unreliable, control the transceiver receive the data from the intelligent infrastructure, and control to perform the at least one of driver-assisted vehicle functions, semi-autonomous vehicle functions, or autonomous vehicle functions of the vehicle based on the data received from the intelligent infrastructure.

The control unit may be configured to, when executing the computer-readable instructions, control to determine the sensor is inoperable or unreliable based on the sensor data.

The control unit may be configured to, when executing the computer-readable instructions, control to detect the object based on the data received from the intelligent infrastructure.

The control unit may be configured to, when executing the computer-readable instructions, control to perform the at least one of driver-assisted vehicle functions, semi-autonomous vehicle functions, or autonomous vehicle functions of the vehicle based on the object.

The driver-assisted vehicle functions, semi-autonomous vehicle functions, or autonomous vehicle functions of the vehicle avoid or mitigate a collision with the object.

The control unit may be configured to, when executing the computer-readable instructions, control to detect the object based on the data received from the intelligent infrastructure and the sensor data.

According to an aspect of an embodiment, there is provided a method of performing safety control of a vehicle, the method including determining a sensor of the vehicle is inoperable or unreliable; transmitting to an intelligent infrastructure a request for data to assist the vehicle to perform at least one of driver-assisted vehicle functions, semi-autonomous vehicle functions, or autonomous vehicle functions of the vehicle, based on determining the sensor is inoperable or unreliable; receiving the data from the intelligent infrastructure; and performing the at least one of driver-assisted vehicle functions, semi-autonomous vehicle functions, or autonomous vehicle functions of the vehicle based on the data received from the intelligent infrastructure.

In the method, determining the sensor of the vehicle is inoperable or unreliable comprises determining the sensor of the vehicle is inoperable or unreliable based on sensor data corresponding to an object in an environment surrounding the vehicle detected by the sensor.

In the method, detecting the object is based on the data received from the intelligent infrastructure.

In the method, performing the at least one of driver-assisted vehicle functions, semi-autonomous vehicle functions, or autonomous vehicle functions of the vehicle comprises performing the at least one of driver-assisted vehicle functions, semi-autonomous vehicle functions, or autonomous vehicle functions of the vehicle based on the object.

In the method, the driver-assisted vehicle functions, semi-autonomous vehicle functions, or autonomous vehicle functions of the vehicle avoid or mitigate a collision with the object.

In the method, detecting the object comprises detecting the object based on the data received from the intelligent infrastructure and the sensor data.

According to an embodiment, there is provided a non-transitory computer-readable recording medium having embodied thereon a program, which when executed by a computer of a vehicle, causes the computer to control a method of performing safety control of a vehicle, the method including determining a sensor of the vehicle is inoperable or unreliable; transmitting to an intelligent infrastructure a request for data to assist the vehicle to perform at least one of driver-assisted vehicle functions, semi-autonomous vehicle functions, or autonomous vehicle functions of the vehicle, based on determining the sensor is inoperable or unreliable; receiving the data from the intelligent infrastructure; and performing the at least one of driver-assisted vehicle functions, semi-autonomous vehicle functions, or autonomous vehicle functions of the vehicle based on the data received from the intelligent infrastructure.

### BRIEF DESCRIPTION OF THE DRAWINGS

The above and other aspects will be more clearly understood from the following brief description taken in conjunction with the accompanying drawings, in which:

FIG. 1 is a block diagram illustrating a system for vehicle control, crash avoidance, and mitigation, according to an embodiment;

FIG. 2 is a flowchart illustrating a method of controlling a vehicle for avoiding collisions via intelligent infrastructure, according to an embodiment; and

FIG. 3 is a flowchart of a method of controlling a vehicle for avoiding collisions via intelligent infrastructure, according to an embodiment.

### DETAILED DESCRIPTION

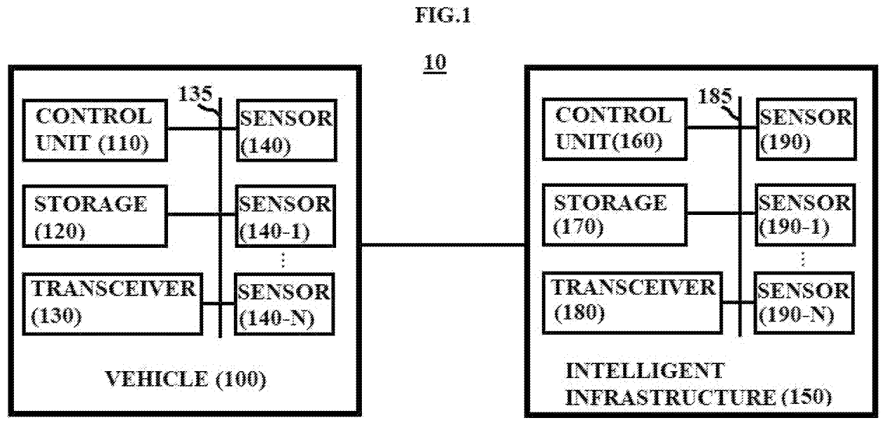

FIG. 1 is a block diagram illustrating a system for vehicle control, crash avoidance, and mitigation, according to an embodiment.

As illustrated in FIG. 1, a system 10 for vehicle control, crash avoidance, and mitigation according to an embodiment includes a vehicle 100 and intelligent infrastructure 150.

The vehicle 100 may be a personal motor vehicle, such as an automobile, a motorcycle, or other motorized vehicle suitable for travel along roadways and other transportation infrastructure. The vehicle 100 may also include commercial vehicles, such as passenger busses, trucks, tractors, or other motorized vehicles suitable for travel along roadways and other transportation infrastructure.

The vehicle 100 may include one or more vehicle systems configured to perform one or more of driver-assisted vehicle functions, semi-autonomous vehicle functions, or autonomous vehicle functions. The driver-assisted vehicle functions may include, for example, level 2 (L2) vehicle automation, such as Advanced Driver Assistance Systems (ADAS) including blind spot detection, vehicle front, vehicle rear, and cross-traffic alerts, collision avoidance, lane departure warning, forward and side collision warning, adaptive cruise control, braking control, speed control, and parking assist. The semi-autonomous vehicle functions may include, for example, level 3 (L3) and level 4 (L4) vehicle automation, such as vehicle navigation and automation only requiring user control or intervention due to environment or vehicle conditions. The autonomous vehicle functions may include, for example, level 5 (L5) vehicle automation, such as full self-driving of the vehicle including navigation and automation without requiring user control.

The vehicle may include a control unit 110, storage 120, a transceiver 130, and a plurality of sensors 140, 140-1, . . . , 140-N.

The control unit 110, the storage 120, the transceiver 130, and the plurality of sensors 140, 140-1, . . . , 140-N may communicate by one or more communication interfaces 135, such as a wired bus, vehicle wire harness, or wirelessly through one or more wireless communication protocols, such as WiFi, Bluetooth, Bluetooth Low Energy (BLE), and the like.

The control unit 110 may be a central processing unit (CPU), microprocessor, automotive microprocessor (MPU), automotive microcontroller (MCU), or other suitable data processing element for controlling operations of the vehicle, including one or more of driver-assisted vehicle functions, semi-autonomous vehicle functions, or autonomous vehicle functions by executing operating instructions, computer-readable codes, application programming, etc. stored in the storage 120 of the vehicle 100.

The storage 120 may be memory, such as random access memory (RAM), solid state or flash memory, electrically erasable programmable read-only memory (EEPROM), or any other suitable data storage element for storing data and/or operating instructions, computer-readable codes, application programming, etc. of the driver-assisted vehicle functions, semi-autonomous vehicle functions, or autonomous vehicle functions of the vehicle 100.

Although the control unit 110 and the storage 120 are illustrated as being embodied as separate components connected via the communication interface 135 in FIG. 1, the artisan of ordinary skill will appreciate that the control unit 110 and storage 120 may be integrated into a single component, such as an application-specific integrated circuit (ASIC) or other suitable electronic component for executing the driver-assisted vehicle functions, semi-autonomous vehicle functions, or autonomous vehicle functions of the vehicle 100.

The transceiver 130 may be communication circuitry configured to communicate information between the vehicle 100 and the intelligent infrastructure 150, such as a roadside unit (RSU) configured to communicate via vehicle-to-everything (V2X) messaging with the vehicle 100. The transceiver 130 may be configured to communicate with the intelligent infrastructure component 150 via one or more communication protocols or standards, such as WiFi, multi-band communication, millimeter wave, or other communication technique suitable for V2X transmission and reception between the transceiver 130 and the intelligent infrastructure 150. Alternatively or additionally, the transceiver may be configured to communicate with the intelligent infrastructure over one or more cellular communication networks and cellular communication standards, such as 3G, 4G, Long Term Evolution (LTE), 5G, and the like.

The transceiver 130 may include, for example, a separate control unit configured to control transmission operations of the transceiver 130, separate storage for storing operating instructions, computer-readable codes, application programming, etc. of communication functions of the transceiver 130, and an antenna, such as a multi-band mobile antenna configured to support one or more communication protocols adapted for V2X communication. The antenna may be an isotropic, omnidirectional, or other antenna structurally configured to transmit or receive messages configured for V2X communication.

The vehicle 100 may include one or more sensors 140, 140-1, . . . , 140-N. The sensors may include vehicle sensors for performing detection of objects, environmental conditions, and other information about the environment or surroundings localized to the vehicle 100. The sensors 140, 140-1, . . . , 140-N may include an acceleration sensor, an air bag deployment sensor, wheel speed sensors, LIDAR sensors, radar sensors, camera systems, precipitation sensors, braking sensors, and the like. The sensors 140, 140-1, . . . , 140-N may be mounted to one or more locations of the vehicle 100, such as an interior of the vehicle, an exterior of the vehicle, a chassis of the vehicle, and the like.

The sensors 140, 140-1, . . . , 140-N may output data of one or more detected conditions of the vehicle 100. For example, an air bag deployment sensor may output information indicating deployment of the air bag of the vehicle 100, a pressure from passenger impact received by the airbag of the vehicle 100, and the like. The wheel speed sensors may output information indicating the wheel speed of the vehicle 100, a rate of deceleration of the wheel speed of the vehicle 100, and the like. The LIDAR sensors, radar sensors, and camera sensors may output information indicating a number of objects proximate to the vehicle 100, a distance of objects proximate to the vehicle 100, a speed and heading of objects proximate to the vehicle 100, and the like. The precipitation sensors may output information indicating a type of precipitation, an amount of precipitation, and the like detected by the vehicle 100. And the braking sensors may output an amount of braking force applied to the vehicle 100, a rate of increase or decrease of braking force applied to the vehicle 100, and the like.

Although a number of sensors have been described, the artisan of ordinary skill will appreciate that the vehicle 100 may include additional sensors that output information localized to the vehicle.

The sensors 140, 140-1, . . . , 140-N may be in communication with the control unit 110 of the vehicle to perform the driver-assisted vehicle functions, semi-autonomous vehicle functions, or autonomous vehicle functions of the vehicle 100 based on sensor data corresponding to objects and environmental conditions detected by the sensors 140, 140-1, . . . , 140-N.

Intelligent infrastructure 150 may include one or more roadside units attached to infrastructure including buildings, sidewalks, traffic lights, traffic signs, and the like.

Intelligent infrastructure 150 may assist the vehicle 100 with both emergency and non-emergency functions, such as to provide the vehicle 100 with data by V2X for executing the driver-assisted vehicle functions, semi-autonomous vehicle functions, or autonomous vehicle functions of the vehicle 100, to identify road conditions, to identify traffic conditions, to identify information about other vehicles proximate to the vehicle 100, and the like.

The intelligent infrastructure may include a control unit 160, storage 170, a transceiver 180, and a plurality of sensors 190, 190-1, . . . , 190-N.

The control unit 160, the storage 170, the transceiver 180, and the plurality of sensors 190, 190-1, . . . , 190-N may communicate by one or more communication interfaces 185, such as a wired bus, vehicle wire harness, or wirelessly through one or more wireless communication protocols, such as WiFi, Bluetooth, Bluetooth Low Energy (BLE), and the like.

The control unit 160 may be a central processing unit (CPU), microprocessor, or other suitable data processing element for controlling operations of the intelligent infrastructure 150, including providing information and sensor data to the vehicle 100 for performing one or more of driver-assisted vehicle functions, semi-autonomous vehicle functions, or autonomous vehicle functions by executing operating instructions, computer-readable codes, application programming, etc. stored in the storage 170 of the intelligent infrastructure 150.

The storage 170 may be memory, such as random access memory (RAM), solid state or flash memory, electrically erasable programmable read-only memory (EEPROM), or any other suitable data storage element for storing data and/or operating instructions, computer-readable codes, application programming, etc. of the intelligent infrastructure 150.

Although the control unit 160 and the storage 170 are illustrated as being embodied as separate components connected via the communication interface 185 in FIG. 1, the artisan of ordinary skill will appreciate that the control unit 160 and storage 170 may be integrated into a single component, such as an application-specific integrated circuit (ASIC) or other suitable electronic component for executing the functions of the intelligent infrastructure.

The transceiver 180 may be communication circuitry configured to communicate information between the vehicle 100 and the intelligent infrastructure 150. The transceiver 180 may be configured to communicate with the vehicle 100 via one or more communication protocols or standards, such as WiFi, multi-band communication, millimeter wave, or other communication technique suitable for V2X transmission and reception between the transceiver 180 and the vehicle 100. Alternatively or additionally, the transceiver 180 may be configured to communicate with the vehicle 100 over one or more cellular communication networks and cellular communication standards, such as 3G, 4G, Long Term Evolution (LTE), 5G, and the like.

The transceiver 180 may include, for example, a separate control unit configured to control transmission operations of the transceiver 180, separate storage for storing operating instructions, computer-readable codes, application programming, etc. of communication functions of the transceiver 180, and an antenna, such as a multi-band mobile antenna configured to support one or more communication protocols adapted for V2X communication. The antenna may be an isotropic, omnidirectional, or other antenna structurally configured to transmit or receive messages configured for V2X communication.

The intelligent infrastructure 150 may include one or more sensors 190, 190-1, . . . , 190-N. The sensors 190, 190-1, and 190-N may include vehicle sensors for performing detection of objects, environmental conditions, and other information about the environment or surroundings localized to the intelligent infrastructure 150. The sensors 190, 190-1, . . . , 190-N may include LIDAR sensors, radar sensors, camera systems, precipitation sensors, audio sensors, and the like. The sensors 190, 190-1, . . . , 190-N may be mounted to one or more roadside units attached to infrastructure including buildings, sidewalks, traffic lights, traffic signs, and the like.

The sensors 190, 190-1, . . . , 190-N may output data of one or more detected objects proximate to the intelligent infrastructure, including the vehicle 100 and other vehicles, pedestrians, animals, debris, traffic conditions, roadway conditions, weather conditions, and the like. For example, the sensors 190, 190-1, . . . 190-N may detect and output information of a travel path of vehicles in the area proximate to the infrastructure component 150, a size (height, weight, length, etc.) and type (car, truck, bus, pedestrian, bicyclist, sign, debris, building, construction barrier, roadway edge etc.) and speed of other objects and vehicles in the area proximate to the infrastructure component 150, and a position and heading of the objects in the area proximate to the infrastructure component.

Although a number of sensors have been described, the artisan of ordinary skill will appreciate that the intelligent infrastructure 150 may include additional sensors that output information localized to the intelligent infrastructure 150.

The sensors 190, 190-1, . . . , 190-N may be in communication with the control unit 160 of the intelligent infrastructure 150 to assist the vehicle 100 to perform the driver-assisted vehicle functions, semi-autonomous vehicle functions, or autonomous vehicle functions of the vehicle 100 based on sensor data corresponding to objects and environmental conditions detected by the sensors 190, 190-1, . . . , 190-N.

Based on the information and sensor data output by the sensors 140, 140-1, . . . , 140-N, the control unit 110 may determine that a collision of the vehicle 100 to an object has occurred. Alternatively or additionally, based on the information output by the sensors 140, 140-1, . . . , 140-N, the control unit 100 may determine that an accident, such as a rollover, disabled tire, broken window or windshield, etc. of the vehicle 100 has occurred.

Under the condition of the collision or accident of the vehicle 100, the one or more vehicle systems are configured to perform driver-assisted vehicle functions, semi-autonomous vehicle functions, or autonomous vehicle functions under control of the control unit 110. For example, in response to the collision or accident of the vehicle 100, the control unit 110 may determine to most quickly navigate the vehicle to a safe position at which the vehicle may be stopped, such as a roadside, while still performing driver-assisted vehicle functions, semi-autonomous vehicle functions, or autonomous vehicle functions to avoid secondary collisions or accidents. Alternatively, in response to the collision or accident of the vehicle 100, the control unit may determine to navigate the vehicle 100 to a hospital, repair facility, service center, or intended destination prior to the collision or accident, while still performing driver-assisted vehicle functions, semi-autonomous vehicle functions, or autonomous vehicle functions.

However, in the instance of a primary collision or accident of the vehicle 100, one or more of sensors 140, 140-1, . . . 140-N of the vehicle 100 may become partially or entirely inoperable. For example, the control unit 110 may determine information and data of one or more of sensors 140, 140-1, . . . 140-N of the vehicle 100 is not received, and therefore the control unit 110 may determine that the sensor 140, 140-1, . . . 140-N is inoperable for supplying information or sensor data to perform driver-assisted vehicle functions, semi-autonomous vehicle functions, or autonomous vehicle functions of the vehicle 100. Alternatively, the control unit 110 may determine information and data of one or more of sensors 140, 140-1, . . . 140-N of the vehicle 100 is unreliable, and therefore the control unit 110 may determine that the sensor 140, 140-1, . . . 140-N is unreliable for supplying information or sensor data to perform driver-assisted vehicle functions, semi-autonomous vehicle functions, or autonomous vehicle functions of the vehicle 100. For example, the control unit 110 may determine that the information or sensor data received from the sensor 140, 140-1, . . . 140-N is incomplete due to incomplete data transmission or format, or inaccurate due to sensor misalignment, sensor offset, or sensor miscalibration of the sensor 140, 140-1, . . . 140-N due to collision.

If the information and sensor data of the sensors 140, 140-1, . . . 140-N is unavailable due to sensor inoperability or unreliable due to sensor malfunction, the control unit 110 may utilize the control unit 160 and information and sensor data of sensors 190, 190-1, . . . 190-N of the infrastructure component 150 to perform driver-assisted vehicle functions, semi-autonomous vehicle functions, or autonomous vehicle functions of the vehicle 100.

In response to detection of the collision or other accident, the control unit 110 may control via the transceiver 130 to transmit a V2X emergency message to intelligent infrastructure 150 via transceiver 180, which may relay the V2X emergency message and/or other information to emergency responder services via one or more communication networks.

The V2X emergency message transmitted by the vehicle 100 to the intelligent infrastructure 150 may include an indication that the information or sensor data received from the sensor 140, 140-1, . . . 140-N is incomplete due to incomplete data transmission or format, or inaccurate due to sensor misalignment, sensor offset, or sensor miscalibration of the sensor 140, 140-1, . . . 140-N due to collision. The indication may identify a type of the sensor 140, 140-1, . . . 140-N, such as a camera, radar, lidar, etc., a type of information or sensor data detected by the sensor 140, 140-1, . . . 140-N, a copy of the information or sensor data detected by the sensor 140, 140-1, . . . 140-N, an identification of the sensor data detected by the sensor 140, 140-1, . . . 140-N that is incomplete or inaccurate, and any other information related to the sensor 140, 140-1, . . . 140-N able to be utilized by the intelligent infrastructure 150 to assist the vehicle 100 to perform the driver-assisted vehicle functions, semi-autonomous vehicle functions, or autonomous vehicle functions of the vehicle 100. Naturally, the sensor data or information may include a speed, position, size, weight, or heading of another vehicle, moving object, or stationary object proximate to the vehicle 100 such that the vehicle 100 may avoid or mitigate collision with the other vehicle or object.

The V2X emergency message transmitted by the vehicle 100 to the intelligent infrastructure 150 may include information indicating an operational parameter of the vehicle 100, such as a global position of the vehicle 100, a relative position of the vehicle 100 relative to the intelligent infrastructure 150, a relative position of the vehicle 100 relative to another object, such as another vehicle, building, roadside, roadside barrier, intersection, traffic signal, railroad track crossing, and the like, a speed of the vehicle 100, a heading of the vehicle 100, and the like able to be utilized by the intelligent infrastructure 150 to assist the vehicle 100 to perform the driver-assisted vehicle functions, semi-autonomous vehicle functions, or autonomous vehicle functions of the vehicle 100.

The V2X emergency message transmitted by the vehicle 100 to the intelligent infrastructure 150 may include a request from the vehicle 100 to the intelligent infrastructure 150 to provide information to assist the vehicle 100 to perform the driver-assisted vehicle functions, semi-autonomous vehicle functions, or autonomous vehicle functions of the vehicle 100, based on the sensor data of the inoperable or inaccurate sensor 140, 140-1, . . . 140-N. The V2X emergency message may include a request from the vehicle 100 to the intelligent infrastructure 150 to provide the vehicle 100 with additional information to supplement the sensor data of the inoperable or inaccurate sensor 140, 140-1, . . . 140-N to assist the vehicle 100 to perform the driver-assisted vehicle functions, semi-autonomous vehicle functions, or autonomous vehicle functions of the vehicle 100.

Alternatively or additionally, the intelligent infrastructure 150 may detect that a collision or other accident involving the vehicle 100 has occurred based on information and sensor data of sensors 190, 190-1, . . . , 190-N of the intelligent infrastructure 150. In response to detection of the collision or other accident, the control unit 160 may control via the transceiver 180 to transmit to the vehicle 100 a request for the vehicle to provide a V2X emergency message to intelligent infrastructure 150 via transceiver 180, which may relay the V2X emergency message and/or other information to emergency responder services via one or more communication networks.

The control unit 160 of the intelligent infrastructure may analyze the information included in the V2X emergency message to provide information to assist the vehicle 100 to perform the driver-assisted vehicle functions, semi-autonomous vehicle functions, or autonomous vehicle functions of the vehicle 100, for example based on the sensor data of the inoperable or inaccurate sensor 140, 140-1, . . . 140-N. The control unit 160 of the intelligent infrastructure 150 may analyze the information included in the V2X emergency message to provide information to assist the vehicle 100 to perform the driver-assisted vehicle functions, semi-autonomous vehicle functions, or autonomous vehicle functions of the vehicle 100, for example to provide the vehicle 100 with additional information to supplement the sensor data of the inoperable or inaccurate sensor 140, 140-1, . . . 140-N to assist the vehicle 100 to perform the driver-assisted vehicle functions, semi-autonomous vehicle functions, or autonomous vehicle functions of the vehicle 100.

In response to receiving the V2X message from the vehicle, or in response to detection of the collision or other accident of the vehicle 100, the control unit 160 of the intelligent infrastructure may determine and transmit to the vehicle 100 information to assist the vehicle 100 to perform the driver-assisted vehicle functions, semi-autonomous vehicle functions, or autonomous vehicle functions of the vehicle 100. For example, based on the V2X emergency message, the intelligent infrastructure 150 may determine to provide the vehicle 100 with replacement sensor data of sensors 190, 190-1, . . . 190-N to replace the sensor data of sensors 140, 190-1, . . . 190-N. Alternatively, the intelligent infrastructure 150 may determine to provide the vehicle 100 with supplemental sensor data of sensors 190, 190-1, . . . 190-N to replace the sensor data of sensors 140, 190-1, . . . 190-N.

The information to assist the vehicle 100 to perform the driver-assisted vehicle functions, semi-autonomous vehicle functions, or autonomous vehicle functions of the vehicle 100 provided by the intelligent infrastructure 150 may include information indicating an operational parameter of the vehicle 100, such as a global position of the vehicle 100, a relative position of the vehicle 100 relative to the intelligent infrastructure 150, a relative position of the vehicle 100 relative to another object, such as another vehicle, building, roadside, roadside barrier, intersection, traffic signal, railroad track crossing, and the like, a speed of the vehicle 100, a heading of the vehicle 100, and the like able to be utilized by the vehicle 100 to perform the driver-assisted vehicle functions, semi-autonomous vehicle functions, or autonomous vehicle functions of the vehicle 100.

The information to assist the vehicle 100 to perform the driver-assisted vehicle functions, semi-autonomous vehicle functions, or autonomous vehicle functions of the vehicle 100 provided by the intelligent infrastructure 150 may include a speed, position, size, weight, or heading of another vehicle, moving object, or stationary object proximate to the vehicle 100 such that the vehicle 100 may avoid or mitigate collision with the other vehicle or object.

Based on the information received from the intelligent infrastructure 150, the control unit 110 of the vehicle 100 may perform the driver-assisted vehicle functions, semi-autonomous vehicle functions, or autonomous vehicle functions of the vehicle 100. For example, the vehicle 100 may calculate a speed, position, size, weight, or heading of another vehicle, moving object, or stationary object proximate to the vehicle 100 such that the vehicle 100 may avoid or mitigate collision with the other vehicle or object; or a global position of the vehicle 100, a relative position of the vehicle 100 relative to the intelligent infrastructure 150, a relative position of the vehicle 100 relative to another object, such as another vehicle, building, roadside, roadside barrier, intersection, traffic signal, railroad track crossing, and the like, a speed of the vehicle 100, a heading of the vehicle 100, and the like. Accordingly, despite an inoperable or inaccurate condition of the sensor 140, 140-1, . . . , 140-N, the vehicle 110 may perform level 2 (L2) vehicle automation, such as Advanced Driver Assistance Systems (ADAS) including blind spot detection, vehicle front, vehicle rear, and cross-traffic alerts, collision avoidance, lane departure warning, forward and side collision warning, adaptive cruise control, braking control, speed control, and parking assist, level 3 (L3) and level 4 (L4) vehicle automation, such as vehicle navigation and automation only requiring user control or intervention due to environment or vehicle conditions, and level 5 (L5) vehicle automation, such as full self-driving of the vehicle including navigation and automation without requiring user control.

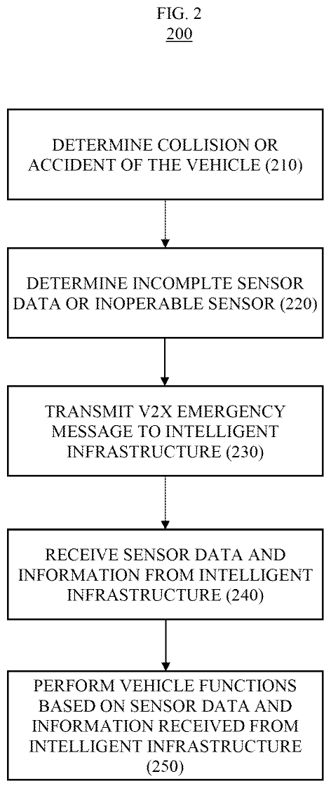

FIG. 2 is a flowchart illustrating a method of controlling a vehicle for avoiding collisions via intelligent infrastructure, according to an embodiment.

FIG. 2 illustrates a method 200 of controlling a vehicle for avoiding collisions via intelligent infrastructure, according to an embodiment. The method 200 illustrated in FIG. 2 may be performed by a vehicle traveling on a roadway, such as the vehicle 100 described above with respect to FIG. 1.

In step 210, based on information and sensor data detected by sensors of the vehicle, the vehicle may determine that a collision of the vehicle to an object has occurred. Alternatively or additionally, based on the information output by the sensors of the vehicle, the vehicle may determine that an accident, such as a rollover, disabled tire, broken window or windshield, etc. of the vehicle has occurred.

To maintain safe operation, under the condition of the collision or accident of the vehicle, the one or more vehicle systems are configured to still perform driver-assisted vehicle functions, semi-autonomous vehicle functions, or autonomous vehicle functions. However, in the instance of a primary collision or accident of the vehicle 100, one or more of sensors of the vehicle may become partially or entirely inoperable.

In step 220, the vehicle may determine information and data of one or more of sensors of the vehicle is unreliable or incomplete, due to sensor malfunction, destruction, misalignment, or the like.

In step 230, if the information and sensor data of the sensors is unavailable due to sensor inoperability or unreliable due to sensor malfunction, the vehicle may transmit a V2X emergency message to intelligent infrastructure.

In step 240, in response to transmission of the V2X emergency message, the vehicle may receive sensor data and or other information from the intelligent infrastructure. The sensor data or information received by the vehicle from the intelligent infrastructure may be utilized by the vehicle to perform the driver-assisted vehicle functions, semi-autonomous vehicle functions, or autonomous vehicle functions. For example, the senor data and information received from the intelligent infrastructure utilized by the vehicle may be used to replace or supplement sensor data of the sensors of the vehicle. Accordingly, the vehicle may calculate positions of objects and the vehicle, speeds of objects and the vehicle, headings of objects and the vehicle, proximity between objects and the vehicle, and the like to continue to safely perform driver-assisted vehicle functions, semi-autonomous vehicle functions, or autonomous vehicle functions.

In step 250, the vehicle may perform one or more of driver-assisted vehicle functions, semi-autonomous vehicle functions, or autonomous vehicle functions utilizing the sensor data or information received from the intelligent infrastructure.

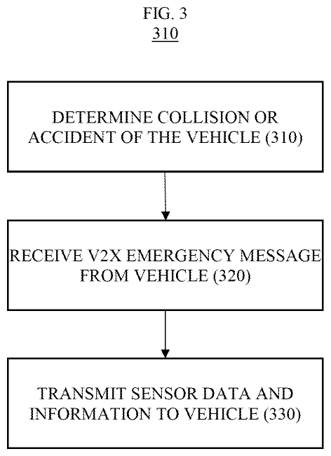

FIG. 3 is a flowchart illustrating a method of controlling a vehicle for avoiding collisions via intelligent infrastructure, according to an embodiment. The method illustrated in FIG. 2 may be performed by intelligent infrastructure, such as the intelligent infrastructure 150 described above with respect to FIG. 1.

In step 310, based on information and sensor data detected by sensors of the intelligent infrastructure, the intelligent infrastructure may determine that a collision of the vehicle to an object has occurred. Alternatively or additionally, based on the information output by the sensors of the intelligent infrastructure, the intelligent infrastructure may determine that an accident, such as a rollover, disabled tire, broken window or windshield, etc. of the vehicle has occurred. Alternatively or additionally, based on information received from the vehicle, the intelligent infrastructure may determine that an accident, such as a rollover, disabled tire, broken window or windshield, etc. of the vehicle has occurred.

In step 320, based on receipt of information or a V2X emergency message from the vehicle, the intelligent infrastructure may determine to provide information to the vehicle to assist the vehicle to perform one or more of driver-assisted vehicle functions, semi-autonomous vehicle functions, or autonomous vehicle functions. For example, the intelligent infrastructure may determine, based on inoperable or inaccurate sensor data of the vehicle, sensor data or information calculated from sensor data or information of the intelligent infrastructure itself.

In step 330, the intelligent infrastructure may transmit the sensor data or information to the vehicle, to assist the vehicle to perform one or more of driver-assisted vehicle functions, semi-autonomous vehicle functions, or autonomous vehicle functions.

As also described above, the intelligent infrastructure provide an external resource of information and sensor data to the vehicle. In the event that sensors of the vehicle become damaged due to collision, information and sensor data of the intelligent infrastructure may be provided to the vehicle to maintain vehicle capabilities to perform one or more of driver-assisted vehicle functions, semi-autonomous vehicle functions, or autonomous vehicle functions. Thereby, secondary collisions may be avoided or mitigated despite limitations of the vehicle.

Aspects of the embodiments described herein may be implemented as computer programs written as computer-executable codes or instructions, whether compiled or uncompiled. The computer programs may be recorded on one or more computer-readable media, such as disk, CD-ROM, or other memory, such as RAM, ROM, flash or solid state memory, etc. Upon execution of the computer programs by a processor, microprocessor, or other processing device, the processor may control a device, such as a vehicle system to perform one or more of driver-assisted vehicle functions, semi-autonomous vehicle functions, or autonomous vehicle functions. Accordingly, robustness and resiliency of driver-assisted vehicle functions, semi-autonomous vehicle functions, or autonomous vehicle functions may be provided.

1. A safety control system of a vehicle, the safety control system comprising:
a sensor configured to output sensor data corresponding to an object in an environment surrounding the vehicle;
a transceiver;
a memory storing computer-readable instructions; and
a control unit configured to, when executing the computer-readable instructions, control to determine the sensor is inoperable or unreliable, control the transceiver to transmit to an intelligent infrastructure a request for data to assist the vehicle to perform at least one of driver-assisted vehicle functions, semi-autonomous vehicle functions, or autonomous vehicle functions of the vehicle, based on determining the sensor is inoperable or unreliable, control the transceiver receive the data from the intelligent infrastructure, and control to perform the at least one of driver-assisted vehicle functions, semi-autonomous vehicle functions, or autonomous vehicle functions of the vehicle based on the data received from the intelligent infrastructure.

2. The safety control system of claim 1, wherein the control unit is configured to, when executing the computer-readable instructions, control to determine the sensor is inoperable or unreliable based on the sensor data.

3. The safety control system of claim 2, wherein the control unit is configured to, when executing the computer-readable instructions, control to detect the object based on the data received from the intelligent infrastructure.

4. The safety control system of claim 3, wherein the control unit is configured to, when executing the computer-readable instructions, control to perform the at least one of driver-assisted vehicle functions, semi-autonomous vehicle functions, or autonomous vehicle functions of the vehicle based on the object.

5. The safety control system of claim 4, wherein the driver-assisted vehicle functions, semi-autonomous vehicle functions, or autonomous vehicle functions of the vehicle avoid or mitigate a collision with the object.

6. The safety control system of claim 3, wherein the control unit is configured to, when executing the computer-readable instructions, control to detect the object based on the data received from the intelligent infrastructure and the sensor data.

7. A method of performing safety control of a vehicle, the method comprising:
determining a sensor of the vehicle is inoperable or unreliable;
transmitting to an intelligent infrastructure a request for data to assist the vehicle to perform at least one of driver-assisted vehicle functions, semi-autonomous vehicle functions, or autonomous vehicle functions of the vehicle, based on determining the sensor is inoperable or unreliable;
receiving the data from the intelligent infrastructure; and
performing the at least one of driver-assisted vehicle functions, semi-autonomous vehicle functions, or autonomous vehicle functions of the vehicle based on the data received from the intelligent infrastructure.

8. The method of claim 7, wherein determining the sensor of the vehicle is inoperable or unreliable comprises determining the sensor of the vehicle is inoperable or unreliable based on sensor data corresponding to an object in an environment surrounding the vehicle detected by the sensor.

9. The method of claim 8, further comprising detecting the object based on the data received from the intelligent infrastructure.

10. The method of claim 9, wherein performing the at least one of driver-assisted vehicle functions, semi-autonomous vehicle functions, or autonomous vehicle functions of the vehicle comprises performing the at least one of driver-assisted vehicle functions, semi-autonomous vehicle functions, or autonomous vehicle functions of the vehicle based on the object.

11. The method of claim 10, wherein the driver-assisted vehicle functions, semi-autonomous vehicle functions, or autonomous vehicle functions of the vehicle avoid or mitigate a collision with the object.

12. The method of claim 9, wherein detecting the object comprises detecting the object based on the data received from the intelligent infrastructure and the sensor data.

13. A non-transitory computer-readable recording medium having embodied thereon a program, which when executed by a computer of a vehicle, causes the computer to control a method of performing safety control of a vehicle, the method comprising:
determining a sensor of the vehicle is inoperable or unreliable;
transmitting to an intelligent infrastructure a request for data to assist the vehicle to perform at least one of driver-assisted vehicle functions, semi-autonomous vehicle functions, or autonomous vehicle functions of the vehicle, based on determining the sensor is inoperable or unreliable;
receiving the data from the intelligent infrastructure; and
performing the at least one of driver-assisted vehicle functions, semi-autonomous vehicle functions, or autonomous vehicle functions of the vehicle based on the data received from the intelligent infrastructure.

14. The non-transitory computer-readable recording medium of claim 13, wherein determining the sensor of the vehicle is inoperable or unreliable comprises determining the sensor of the vehicle is inoperable or unreliable based on sensor data corresponding to an object in an environment surrounding the vehicle detected by the sensor.

15. The non-transitory computer-readable recording medium of claim 14, wherein the method further comprises detecting the object based on the data received from the intelligent infrastructure.

16. The non-transitory computer-readable recording medium of claim 15, wherein performing the at least one of driver-assisted vehicle functions, semi-autonomous vehicle functions, or autonomous vehicle functions of the vehicle comprises performing the at least one of driver-assisted vehicle functions, semi-autonomous vehicle functions, or autonomous vehicle functions of the vehicle based on the object.

17. The non-transitory computer-readable recording medium of claim 16, wherein the driver-assisted vehicle functions, semi-autonomous vehicle functions, or autonomous vehicle functions of the vehicle avoid or mitigate a collision with the object.

18. The non-transitory computer-readable recording medium of claim 15, wherein detecting the object comprises detecting the object based on the data received from the intelligent infrastructure and the sensor data.
